(19) United States
(12) Patent Application Publication
(10) Pub. No.: US 2015/0039926 A1
(43) Pub. Date: Feb. 5, 2015

(54) DELAY SYSTEM AND METHOD FOR SERVER

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: MING YU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/261,711

(22) Filed: Apr. 25, 2014

(30) Foreign Application Priority Data
Aug. 1, 2013 (CN) 2013103310255

(51) Int. Cl. G06F 1/30

(52) U.S. Cl. CPC G06F 1/30
USPC 713/340; 713/300

(57) ABSTRACT

A system of delaying the shutdown of a server, the server including a data processing unit connected to an external power supply unit. The delay system includes a delay controlling unit, a first discharging unit, and a second discharging unit. The delay controlling unit is coupled to the data processing unit and thus the external power supply unit. On shutdown, the first discharging unit discharges to provide power for data processing unit, the second discharging unit is invoked to continue supplying power for a necessary period when the discharging voltage value of the first discharging unit is found to be less than a predetermined voltage value.

### RELATED APPLICATIONS

This application claims priority to China Patent Application No. 201310331025.5 filed on Aug. 1, 2013 in the China Intellectual Property Office, the contents of which are hereby incorporated by reference.

### FIELD

The disclosure generally relates to delay systems and methods, and particularly relates to a delay systems and methods applied to a server.

### BACKGROUND

A blade server may have a power supply system, a plurality of servers, and a plurality of other loads, such as fans. The power supply system is connected to the plurality of servers and the plurality of loads, for providing power for the servers and the plurality of loads. When the power supply system stops providing power, if the other loads are heavier in terms of electrical consumption, the servers may be starved of power during the power-down process, so the server may lose some data in buffering process.

### BRIEF DESCRIPTION OF THE DRAWINGS

Many aspects of the embodiments herein can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of an electronic device.

FIG. 2 is a flowchart showing one embodiment of a delay method applied to a server.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

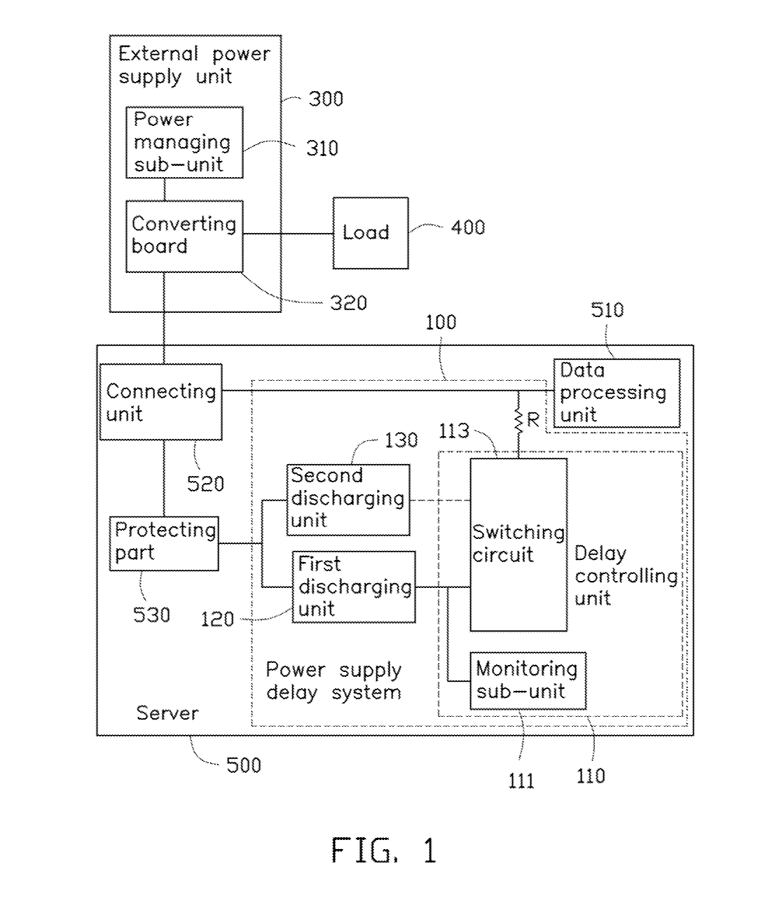

FIG. 1 shows one embodiment of an electronic device. The electronic device includes an external power supply system 300, a plurality of servers 500 (only one is shown), and a delay system 100 located in each of the plurality of servers 500.

The external power supply unit 300 includes a power managing sub-unit 310, and a converting board 320 coupled to the power managing sub-unit 310. The converting board 310 is connected to a plurality of loads 400 and the plurality of servers 500. The power managing sub-unit 310 provides power for the servers 500 and the loads 400. The loads 400 may be fans or other loads.

The delay system 100 includes a delay controlling unit 110, a first discharging unit 120, and a second discharging unit 130. The first discharging unit 120 and the second discharging unit 130 are coupled to the connecting unit 520 via the protecting part 530.

The delay controlling unit 110 includes a monitoring sub-unit 111 and a switching circuit 113. The monitoring sub-unit 111 is connected to the switching circuit 113 and the first discharging unit 120, for obtaining the discharging voltage value of the first discharging unit 120. The switching circuit 113 is coupled to the data processing unit 510 via a resistor R.

When the external power supply unit 300 stops providing power to the server 500, the first discharging unit 120 begins to discharge, as it provides continuing power for the data processing unit 510 and the loads 400. The monitoring unit 111 obtains the discharging voltage value of the first discharging unit 120 and determines if the discharging voltage value is less than or equal to a predetermined value. The switching circuit 113 disconnects the first discharging unit 120 from the data processing unit 510 and connects the second discharging unit 130 to the data processing unit 510. The second discharging unit 130 continues to provide power to the data processing unit 51 as the unit 130 discharges, to provide a predetermined time for the data processing unit 510 for storage data.

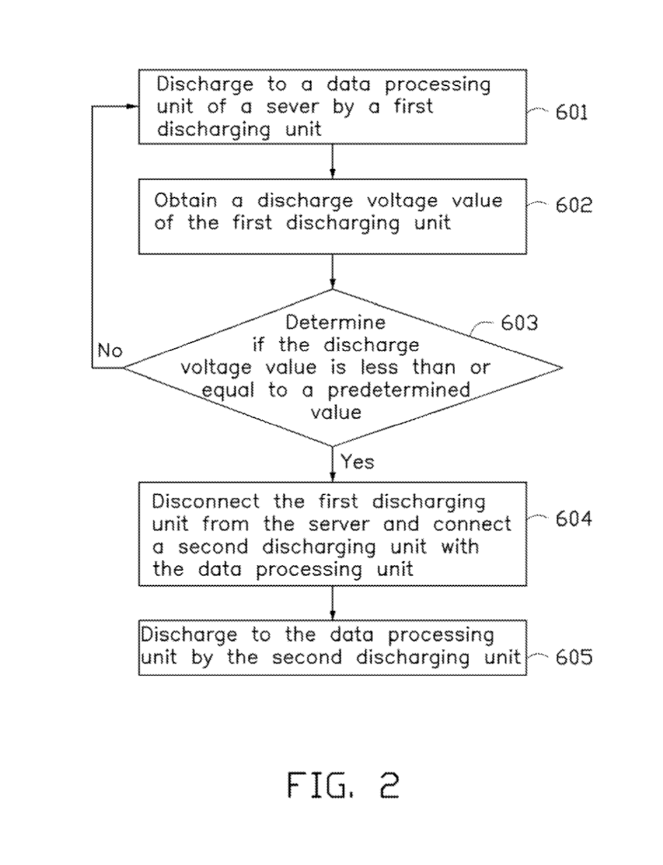

In relation to the external power supply unit 300 ceasing to supply power, FIG. 2 shows a flowchart showing one embodiment of a delay method applied to the server 500. The delay method comprises the following steps.

In step 601, the first discharging unit 120 continues to discharge to provide power for the data processing unit 510 as the unit 120 discharges.

In step 602, the monitoring sub-unit 111 obtains the discharging voltage value of the first discharge unit 120.

In step 603, the monitoring sub-unit 111 determines if the discharging voltage value is less than or equal to the predetermined value. When the discharging voltage value is less than or equal to the predetermined value, the process goes to step 604, if not, to step 601.

In step 604, the switching circuit 113 disconnects the first discharging unit 120 from the data processing unit 510 and connects the second discharging unit 130 to the data processing unit 510

In step 605, the second discharging unit 130 discharges to provide power for the data processing unit 510.

Certain steps or methods described herein may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

The embodiments described herein are illustrative, and should not be construed as limited the following claims.

What is claimed is:

1. A delay system for a server, the server comprising a data processing unit connected to an external power supply unit, the external power supply unit configured to provide power for the data processing unit, and the delay system comprising:
a delay controlling unit configured to be coupled to the data processing unit and the external power supply unit;
a first discharging unit coupled to the delay controlling unit and configured to be coupled to the external power supply unit, and the first discharge unit configured to discharge to provide power for data processing unit when the external power supply unit stop providing power for the data processing unit; and
a second discharging unit configured to be coupled to the external power supply unit;
wherein the delay controlling unit is configured to connect the second discharging unit with the data processing unit when the discharging voltage value of the first discharging unit is less than a predetermined voltage value, and the second discharging unit is configured to discharge to provide power for the data processing unit.

2. The delay system of claim 1, wherein the delay controlling unit comprises a monitoring sub-unit, the monitoring sub-unit is configured to obtain the discharging voltage value and determine if the discharging voltage is less than the predetermined voltage value, and the delay controlling unit is configured to disconnect the first discharging unit with the data processing unit and connect the second discharging unit with the data processing unit when the discharging voltage value of the first discharging unit is less than the predetermined voltage value.

3. The delay system of claim 2, wherein the delay controlling unit further comprises a switching circuit, and the switching circuit is configured to disconnect the first discharging unit with the data processing unit and connect the second discharging unit with the data processing unit when the discharging voltage value of the first discharging unit is less than the predetermined voltage value.

4. The delay system of claim 3, wherein the switching circuit is coupled to the first discharging unit and connected to the data processing unit via a resistor.

5. The delay system of claim 1, wherein the first discharging unit and the second discharging unit are rectifier.

6. A delay method for a server, the delay method comprising;
discharging to provide power for a data processing unit of a server by a first discharging unit;
obtaining a discharging voltage value of the first discharging unit;
connecting the data processing unit with a second discharging unit when the discharging voltage is less than a predetermined voltage value; and
discharging to provide power for the data processing unit by the second discharging unit.

7. The delay method of claim 6, wherein after the step of obtaining a discharging voltage value of the first discharging unit and before the step of connecting the data processing unit with a second discharging unit, the method further comprises:
determining if the discharging voltage value is less than or equal to the predetermined voltage value; and
disconnecting the first discharging unit with the data processing unit.

8. An electronic device comprising:
a server comprising a data processing unit;
an external power supply unit connected to the data processing unit and configured to provide power to the data processing unit; and
a electronic device comprising a delay controlling unit, a first discharging unit, and a second discharging unit; the first discharging unit being coupled to the data processing unit and the external power supply unit, and the second discharging unit being coupled to the external power supply unit,
wherein the first discharge unit is configured to discharge to provide power for data processing unit when the external power supply unit stops to provide power for the data processing unit, and the delay controlling unit is configured to connect the second discharging unit with the data processing unit when the discharging voltage value of the first discharging unit is less than a predetermined voltage value.

9. The electronic device of claim 8, wherein the delay controlling unit comprises a monitoring sub-unit, the monitoring sub-unit is configured to obtain the discharging voltage value and determine if the discharging voltage is less than the predetermined voltage value, and the delay controlling unit is configured to disconnect the first discharging unit with the data processing unit and connect the second discharging unit with the data processing unit when the discharging voltage value of the first discharging unit is less than the predetermined voltage value.

10. The electronic device of claim 9, wherein the delay controlling unit further comprises a switching circuit, and the switching circuit is configured to disconnect the first discharging unit with the data processing unit and connect the second discharging unit with the data processing unit when the discharging voltage value of the first discharging unit is less than the predetermined voltage value.

11. The electronic device of claim 9, wherein the switching circuit is coupled to the first discharging unit and connected to the data processing unit via a resistor.

12. The electronic device of claim 11, wherein the server further comprises a connecting unit, the connecting unit is coupled to the data processing unit, the resistor and the external power system.

13. The electronic device of claim 12, wherein the server further comprises a protecting part, the protecting part is coupled to the connecting unit and the first discharging unit and the second discharging unit.

14. The electronic device of claim 8, wherein the first discharging unit and the second discharging unit are rectifier.
